(19) United States
(12) Patent Application Publication
(10) Pub. No.: US 2007/0079299 A1
(43) Pub. Date: Apr. 5, 2007

(54) Method, apparatus and program storage device for representing eclipse modeling framework (EMF) ecore models in textual form

(75) Inventor: Christopher Jude Daly, Beaverton, OR (US)

Correspondence Address: DAVID W. LYNCH;CHAMBLISS, BAHNER & STOPHEL, 1000 TALLAN SQUARE-S, TWO UNION SQUARE, CHATTANOOGA, TN, 37402, US

(73) Assignee: International Business Machines Corporation

(21) Appl. No.: 11/242,195

(22) Filed: Oct. 3, 2005

(51) Int. Cl. G06F 9/45; G06F 9/44

(52) U.S. Cl. 717/141; 717/104; 717/106

(57) ABSTRACT

A method, apparatus and program storage device for representing software models in textual form. A representation of a computer program selected from a group comprising a model and source code representing a model is provided. A counterpart to the selected representation of the computer program is produced.

### FIELD OF THE INVENTION

This disclosure relates in general to a software development tools, and more particularly to a method, apparatus and program storage device for representing modeling framework models in textual form.

### BACKGROUND

The mass popularization of the Internet has led to new technologies, programming languages and design systems that have usually required separate tools for programming and designing. For example, a developer may have to use Java, Python, C++ and other languages to support a single application. However, significant strides have been made recently in the integration of development tools. One goal in the integration of development tools is to reduce the large number of incompatible development environments and to increase the reuse of the common components in those environments. By using the same common framework, a development team could leverage components developed by others, integrate software components to a high degree, and allow developers to roam among projects.

To abstract the configuration necessary to piece together command line utilities in a cohesive unit, which theoretically reduces the time to learn a language, and increases developer productivity, integrated development environments (IDEs) were developed. An IDE typically provides a large numbers of features for authoring, modifying, compiling, deploying and debugging software. An IDE provides the tight integration of various development tasks can lead to further productivity increases.

In addition, to reduce the large number of incompatible development environments being offered to customers and to increase the reuse of the common components in those environments, an integrated platform for development tools was needed. One of the early such platforms was Eclipse. Eclipse is a platform that enabled partners to easily extend products built on it, using the plug-in mechanisms provided by the platform. The subsequent path to open source and enabling of a much wider audience and ecosystem was a natural progression. The Eclipse open source project was announced in November 2001 by a group of companies that formed the initial Eclipse Consortium. From there, the small initial project burgeoned into a collection of related projects.

Eclipse is Java-based and provides a platform-independent software framework and a set of services for building a development environment from plug-in components. Eclipse includes a standard set of plug-ins, including the Java Development Tools (JDT) and the Plug-in Development Environment (PDE), that enable developers to extend Eclipse and build tools that can be integrated seamlessly with the Eclipse environment.

The Eclipse framework provides the facilities that the components of development tooling need to interact. The Eclipse platform is based upon the creation of a workspace that locally maintains a developer's own copy of project components. Developers gain access to workspace elements through the “workbench” that establishes GUI-based frames for development debuggers, the tree structure of component relationships, profilers, object editors and access controls for interacting with the repository. The development objects are not limited to traditional source code, but may also include tables of national language translations, graphic objects, models, etc.

The Eclipse Modeling Framework (EMF) is a tool distributed under the Eclipse umbrella. It is a tool created in the spirit of the OMG's Model Driven Architecture (MDA) and an excellent example of the power of MDA. EMF is capable of creating sophisticated editors from abstract business models. These editors are implemented as plugins for Eclipse. EMF creates feature complete implementations including persistence, business model implementation, editing framework and editors.

EMF was started as a Meta Object Facility (MOF) of the Object Management Group (OMG) implementation and has evolved to what it is now. EMF is an enhancement of MOF2.0. EMF enhances the MOF 2.0 ECore model to ease the design and implementation of a structured model. The Eclipse Modeling Framework is part of the Model Driven Architecture (MDA). It is the current implementation of a portion of the MDA in the Eclipse family tools. The idea behind MDA it is to be able to develop and manage the whole application life cycle by putting the focus on the structured model, rather than specific technologies or platforms. The model itself is described in a meta-model. Then, by using mappings, the model is used to generate software artifacts, which will implement the real system. Two types of mappings are defined: Metadata Interchange, where documents like XML, DTD, and XSD are generated; and Metadata Interfaces, which target Java or any other language and generate IDL code. MDA is currently under the standardization process at the OMG.

The model used to represent models in EMF is called ECore. ECore is itself an EMF model, and thus is its own meta-model. From the definition of the ECore model, the EMF code generator generates interfaces and implementation classes that provide: class factory, metadata management, getters/setters, object navigation, serialization/deserialization, undoable commands, notifications, and Eclipse plugin for creating and modifying instance data. However, before using the EMF code generator, a user should define an ECore model that is used to generate the implementation classes.

To build and textually visualize EMF ECore models, tools such as annotated Java, UML tools, XML schema and the tree-based ECore model editor have been used. However, these solutions have their disadvantages. For example, UML, XML Schema and Java are general-purpose languages that have many other uses and thus have extraneous features that do not map to ECore. Further, using annotated Java to represent an ECore model requires that the model be distributed over many files. The tree-based ECore model does not have a simple textual editing mode.

It can be seen then that there is a need for a method, apparatus and program storage device for representing software models in textual form.

### SUMMARY OF THE INVENTION

To overcome the limitations in the prior art described above, and to overcome other limitations that will become apparent upon reading and understanding the present specification, the present invention discloses a method, apparatus and program storage device for representing software models in textual form.

The present invention solves the above-described problems by providing an interface for switching between textual syntax of source code and an equivalent software model and associated tools for writing and editing the visualized software model.

A data structure stored on a computer-readable medium in accordance with the principles of the present invention includes elements for selecting files for processing and a syntax for representing models in textual form such that, when the data structure is read by a computing device, the computing device can map between a model of an application and a source file representing the model.

In another embodiment of the present invention, a method for working with models is provided. The method includes selecting information from a group comprising a model and source code representing the model and producing a counterpart to the selected information.

In another embodiment of the present invention, an apparatus is provided. The apparatus includes a processor and a memory coupled to said processor and operable to store program instructions in a platform-independent programming language, wherein the program instructions are executable by the processor to provide a representation of a computer program selected from a group comprising a model and source code representing the model and produce a counterpart to the selected representation of the computer program.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 is a schematic block diagram of a generic computer system, which may provide an operating environment according to an embodiment of the present invention;

FIG. 2 is a simple representation of an ECore model according to an embodiment of the present invention;

FIG. 3 illustrates an interface between source code files and EMF ECore models according to an embodiment of the present invention;

FIG. 4 is a flow chart of a method for creating a source file representing an ECore model according to an embodiment of the present invention;

FIG. 5 is a flow chart of a method for creating an ECore model from a source file according to an embodiment of the present invention;

FIG. 6 illustrates a system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for representing software models in textual form. An interface for switching between textual syntax of source code and an equivalent software model is provided. Tools for writing and editing the visualized model are also provided.

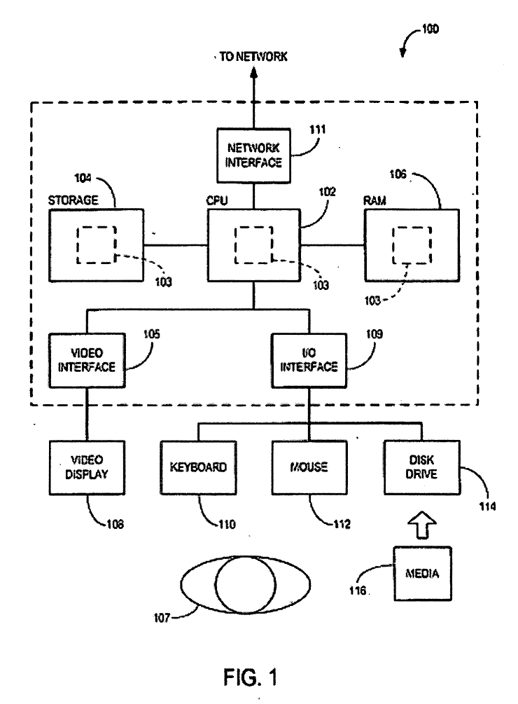

Embodiments of the present invention for mapping between a software model and a source file representing the model will be described below with reference to FIGS. 1-6. FIGS. 1-6 are described with reference to Ecore models within the Eclipse Modeling Framework (EMF). However, those skilled in the art will recognize that embodiments of the present invention are not meant to be limited to use with Ecore models. Rather, embodiments of the present invention are applicable to other types of model frameworks.

FIG. 1 illustrates a computer system 100 that may provide an operating environment for an embodiment of the present invention. The computer system 100 may include a central processing unit (“CPU”) 102 connected to a storage unit 104 and to a random access memory (“RAM”) 106. The CPU 102 may execute a software program 103 which may be stored in the storage unit 104 and loaded into RAM 106 as required. A user 107 may interact with the computer system 100 using a video display 108 connected to computer system 100 via a video interface 105, and various input/output devices such as a keyboard 110, mouse 112, and disk drive 114 connected by an I/O interface 109. The disk drive 114 may be configured to accept or, alternatively, include computer readable media 116. Optionally, the computer system 100 may be network enabled via a network interface 111. The computer readable media 116 may be configured to provide a data structure that includes an element for selecting files for processing and a syntax for representing models in textual form such that, when the data structure is read by a computing device, the computing device can map between a model of an application and a source file representing the model. The source code is a counterpart to the EMF ECore model and vice versa. The computer readable media 116, as will be described in greater detail below, may be configured to provide instructions, that when executed by CPU 102 causes information from a group comprising source code representing a model and a model to be selected and a counterpart to the selected information to be produced. It will be appreciated that the computer system 100 of FIG. 1 is merely illustrative and is not meant to be limiting in terms of the type of operating system for the invention. Those skilled in the art will also recognize that the environment illustrated in FIG. 1 is not intended to limit the present invention. Indeed, those skilled in the art will recognize that other alternative hardware environments may be used without departing from the scope of the present invention.

Eclipse is an open-source, Java-based, extensible development platform that provides a framework and a set of services for building a development environment from plug-in components. Eclipse includes a standard set of plug-ins, including the Java Development Tools (JDT) and the Plug-in Development Environment (PDE), that enable developers to extend Eclipse and build tools that can be integrated seamlessly with the Eclipse environment.

As a tool integration platform, Eclipse has a varied and ever-growing set of editors and utilities, one of which is the Eclipse Modeling Framework (EMF). EMF is a modeling and data integration framework, as well as a code generation framework for building plug-ins for Eclipse. EMF aids in the construction of object oriented software models. For example, from a description of a model in Java, XML Schema, or from a XML file (RRose, ArgoUML, etc), EMF can build all the code necessary to work with the model in Java. EMF generates most, if not all the code necessary for creating, manipulating, saving, and loading instances of the classes in the model. If for some reason, the design of the model is modified, only the model needs to be modified and EMF will regenerate the code without affecting surrounding code. In addition, EMF provides persistence, model change notification, and a reflective API for manipulating EMF objects generically.

EMF uses ECore, which is a meta-language that describes models and provides runtime support for those models. ECore models are based upon a subset of the OMG Meta Object Facility 2.0 (MOF) called Essential MOF (EMOF). EMF models are persisted as XML Model Interchange (XMI) documents. EMF provides viewing and command-based editing of the model as well as a basic editor for manipulating and serializing instance documents based on an EMF model.

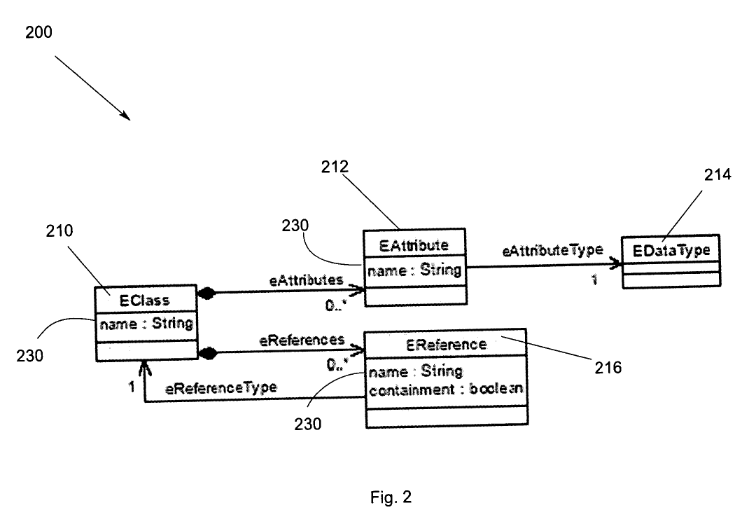

FIG. 2 is a simple representation of an ECore model 200 according to an embodiment of the present invention. In FIG. 2, the ECore model includes an EClass 210, EAttribute 212, EDataType 214 and EReference 216. The ECore model 200 shown in FIG. 2, for ease of explanation, does not illustrate the base classes. For example, in a real ECore model the objects EClass 210, EAttribute 212 and EReference 216 share a common base class, EnamedElement (not shown), which defines the name attribute. However, in FIG. 2, these attributes are shown explicitly in the classes themselves, i.e., the “name: String” 230.

In the ECore model 200 shown in FIG. 2, the four ECore objects demonstrate the nature of communication between them. The EClass object 210 is used to represent a modeled class. It may include a name, zero or more attributes, and zero or more references. EAttribute 212 is used to represent a modeled attribute. Attributes may include a name and a type. EReference 216 is used to represent one end of an association between classes. EReference 216 may include a name, a boolean flag to indicate if it represents containment, and a reference (target) type, which is another class. EDataType 214 is used to represent the type of an attribute. A data type may be a primitive type like “int” or float or an object type like java.util.Date.

Accordingly, EMF is a Java/XML framework for generating tools and other applications based on simple class models. EMF may be used to convert models into efficient, correct, and easily customizable Java code. Models can be created using annotated Java, XML documents, or modeling tools like Rational Rose® from International Business Machines Corporation, then imported into EMF. The code generator turns a model into a set of Java implementation classes. These classes are extensible and regeneratable thereby allowing modification by adding user-defined methods and instance variables. When the model changes, the implementation classes may be regenerated, and the modifications will be retained. This works both ways, i.e., changes in the code can be used to update the model.

However, these solutions have their disadvantages. For example, UML, XML Schema and Java are general-purpose languages that have many other uses and thus have extraneous features that do not map to ECore. Further, using annotated Java to represent an ECore model requires that the model be distributed over many files. The tree-based ECore model does not have a simple textual editing mode.

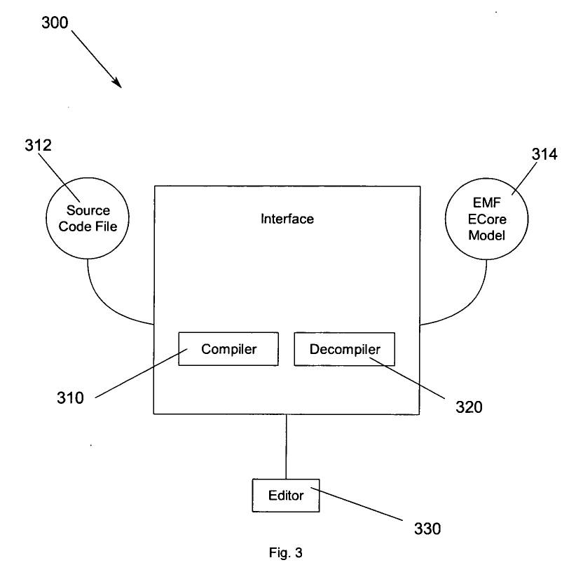

FIG. 3 illustrates an interface 300 between source code files 312 and EMF ECore models 314 according to an embodiment of the present invention. In FIG. 3, the interface 300 includes a compiler 310 that reads the source code file 312 and produces an equivalent ECore model 314. The interface 300 also includes a decompiler 320 that reads an ECore model 314 and produces an equivalent source code file 312. The ECore models 314 are textually represented by the source code file 312 according to a predetermined syntax. In one embodiment of the present invention, an editor 330 is included for providing syntax highlighting and tools that aid in writing source code 312. The compiler 310 maps the textual language of the source code file 312 directly to an ECore model 314 without extraneous constructs and allows a complete ECore model 314 to be represented in a single text file 312. This is particularly useful when text is preferable to tree-based or diagrammatic notations.

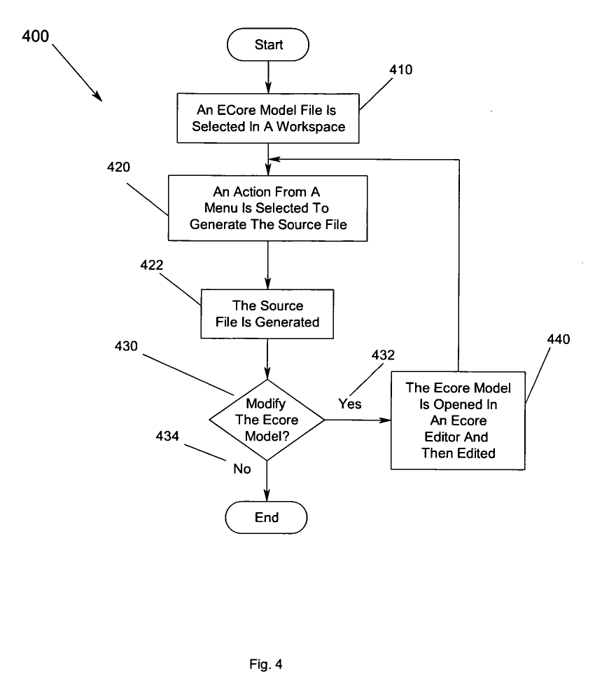

FIG. 4 is a flow chart 400 of a method for creating a source file representing an ECore model according to an embodiment of the present invention. An ECore model file is selected in a workspace 410. A source file to be generated 420 is selected by, for example, selecting an action from a menu. The source file is generated 422. Users can create a source file that is equivalent to an Ecore model by selecting an Ecore model in the Eclipse workspace. A decision is made whether to modify the ECore model 430. The source file represents an entire Ecore model and it uses a Java-like syntax familiar to many programmers. An editor and a parser for the language are provided. If the ECore model is to be modified 432, the ECore model is opened in an editor and edited 440. Thereafter, the process returns to select an action from a menu to generate the source file 420. If not 434, the process ends.

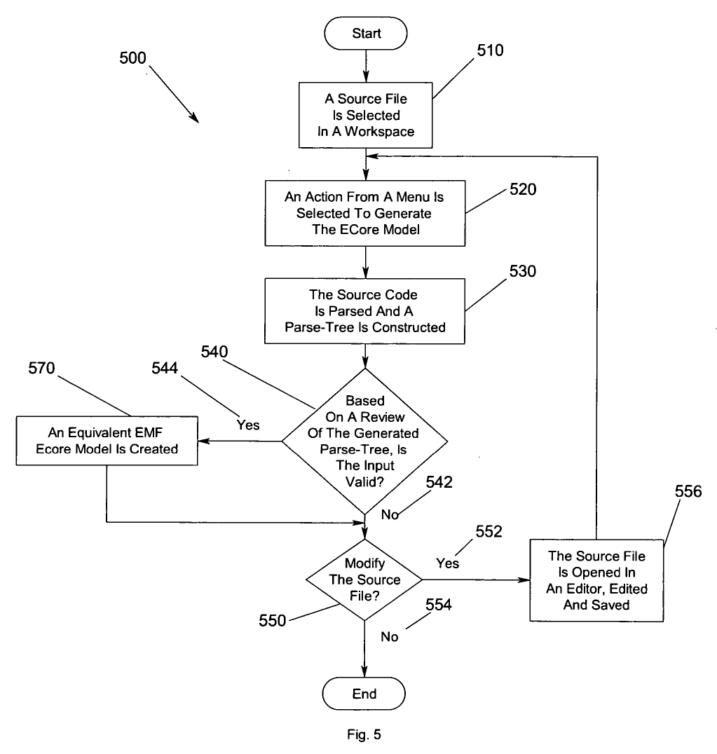

FIG. 5 is a flow chart 500 of a method for creating an ECore model from a source file according to an embodiment of the present invention. A source file is selected in a workspace 510. An action from a menu is selected to generate the ECore model 520. The source code is parsed and a parse-tree is constructed 530. Based on a review of the generated parse-tree, whether the input is valid is determined 540. If the input is invalid 542, a decision is made whether to modify the source file 550. Source files can be edited by opening them in an Eclipse editor, which includes syntax highlighting, outline view, and related editor features. If the source file is to be edited 552, the source file is opened in an editor, edited and saved 556. The process then returns to select an action form a menu to generate the ECore model 520. If the input verified in 540 is valid 544, then an equivalent EMF ECore model is created based on the existing source file 570. Users can create an Ecore model equivalent to the selected source file by selecting from source files in the Eclipse workspace and navigating to select an action for generating an ECore model. The equivalent EMF Ecore model is written to disk. Then, the decision is made to modify the source file 550. If the source file is not to be modified 554, the process ends.

Within the Eclipse modeling framework, a workspace is a directory where projects are stored. According to an embodiment of the present invention, tooling and textual visualization of ECore models are provided. The rules and syntax for providing textual visualization of ECore models is referred to as Emfatic. A workbench consists of views for providing alternate way of navigation, collections of views that are referred to as perspectives and editors that associated with the file types. External editors can also be used with editors.

In terms of syntax, Epackage is a grouping mechanism. Namespace implements the naming hierarchy and provides name resolution operations. In EMF, only certain specific classes (e.g. EPackage, EClass, EEnum) contain specific operations to lookup some of their content by name. EType defines things that have “type” and EClass is used to define “things.”

A model with an EPackage named “test” containing a single EClass named “Foo” for example, may be provided by the following example:

package test;
class Foo { }

The keyword package introduces an ECore EPackage and the identifier following it maps to the name attribute of the generated EPackage. The only thing required in a source file is a package declaration. This required element is called the main package declaration and the EPackage it defines will contain (directly or indirectly) all of the other elements of the generated ECore model.

The values for the EPackage attributes nsURI and nsPrefix may be specified as shown in the following example:

@namespace(uri=“http://www.eclipse.org/emf/2002/Ecore”,
prefix=“ecore”)
package ecore;

Note that the code is case-sensitive in most contexts (reflecting the underlying case-sensitivity of ECore), however the identifiers namespace, uri and prefix in the text above could be written in any case. Also note that the order of declaration for uri and prefix is not important. The syntax of the @namespace declaration is actually a special case of the more general syntax for declaring EAnnotations.

ECore allows packages to be nested inside packages. The syntax for nested packages differs from that of the main package. Nested package declarations are followed by a curly-brace bracketed region, which encloses the nested package contents.

The example below demonstrates package nesting.

package main;
package sub1 {
}
package sub2 {

package sub2_1 {

}

package sub2_2 { }

}

In the ECore model generated from the above program, the top-level package named “main” will contain two packages, “sub1” and “sub2”, and package sub2 will contain the packages “sub2_1” and “sub2_2”.

Import statements allow for types defined in external ECore models to be referenced. All import statements must immediately follow the main package declaration. The example below demonstrates the basic syntax of import statements. The double-quoted string literal following the import keyword must contain the URI of an ECore model.

package main;
import “platform:/resource/proj1/foo.ecore”;
import “http://www.eclipse.org/emf/2002/Ecore”;
package sub { }

Note that Ecore.ecore is automatically imported, so the second import in the program above is not really necessary.

The syntax for class declarations is very similar to Java. However a few differences are required to allow for all of the possibilities of ECore. The example below containing four simple class declarations demonstrates the use of the keywords class, interface and abstract and also introduces comments (both styles of Java comments are allowed). The comments detail the mapping from text to the EClass attributes interface and abstract.

package main;

| | |
|---|---|
| class C1 { } | // isInterface=false, isAbstract=false |

| | |
|---|---|
| abstract class C2 { } | // isInterface=false, isAbstract=true |

| | |
|---|---|
| interface I1 { } | // isInterface=true, isAbstract=false |

| | |
|---|---|
| abstract interface I2 { } | // isInterface=true, isAbstract=true |

Inheritance is specified with the keyword extends. Unlike Java, there is no implements keyword to distinguish inheritance from interface implementation. The example below defines an inheritance hierarchy.

package main;
class A { }
class B { }
class C extends A, B { }
class D extends C { }

If necessary, the value of the EClassifier attribute instanceClassName can be specified. The class EStringToStringMapEntry from Ecore.ecore provides an example of this:

class EstringToStringMapEntry : java.util.Map$Entry {

// ... contents omitted ...

}

Note that if the class both extends other classes and specifies a value for instanceClassName, the extends clause must precede the instanceClassName clause.

Declaring an EDataType is accomplished as follows. First note that as with classes, the value of the EClassifier attribute instanceClassName follows the colon after the name of the datatype. However specifying instanceClassName is required for datatypes (while it is optional for classes). An example of Four EdataType declarations are shown below:

datatype EInt : int;
datatype EIntegerObject : java.lang.Integer;
transient datatype EJavaObject : java.lang.Object;
datatype EFeatureMapEntry :
org.eclipse.emf.ecore.util.FeatureMap$Entry;
datatype EByteArray : “byte[ ]”; // Note: [ and ] are not legal identifier
characters
and must be in quotes

Note that one of ordinary skill in the art will recognize that the comment above beginning with “//” should not be split between two lines. The keyword transient in the third datatype declaration above indicates that the value of the EDataType serializable attribute should be set to false. This is a good time to point out that the modifier keywords introduced so far (abstract and interface) are applied to reverse the default ECore attribute values (by default EClass attributes abstract and interface are both false). In the case of the EDataType attribute serializable, the default value is true so a keyword is used, transient, that means the opposite of serializable.

The last two datatypes illustrate a subtle syntactic point. The value specified for the instanceClassName attribute must either be a valid qualified identifier (a dot or dollar-sign separated list of identifiers such as java.lang.Object in the third datatype above) or it must be enclosed in double quotes. The datatype EFeatureMapEntry contains the character ‘$’ which, following Java syntactic rules, is a legal qualified identifier separator. The datatype EByteArray contains the characters ‘[’ and ‘]’ that are not legal in a qualified identifier.

The overall point to make about qualified identifier versus double-quoted syntax for instanceClassName is that the typical datatype declaration can use the former and thus should be easier to read and edit, while the latter is available when needed and allows for arbitrary string text to be placed in the generated ECore model. There are some other contexts where the option to use either a qualified identifier or double-quoted string is provided (see the section on Annotations below for another example of this).

Syntax that maps to EEnum and EenumLiteral as follows.

enum E {

A=1;
B=2;
C=3;

}

Note that the simple assignment expressions specify the value attribute of each generated EEnumLiteral. In fact, specifying enumeration literal values is optional and Reasonable values are generated when they are left unspecified. The code and comments below describe the rules for this.

enum E {

A; // = 0 (if not specified, first literal has value 0)
B = 3;
C; // = 4 (in general, unspecified values are 1 greater than previous
value)
D; // = 5

}

MapEntry classes (such as EStringToStringMapEntry in Ecore.ecore) can be specified in either of two ways. The “longhand” way is to declare a class with features named key and value and with [instanceClass=java.util.Map$Entry] as suggested at the end of section 2.1 above. But there is a convenient shorthand notation, which achieves the same result:

mapentry EStringToStringMapEntry:String->String;

The expression following the colon gives the type of the MapEntry key structural feature followed by the->operator, followed by the type of the value structural feature. Type expressions can be more complex than shown in the example above and are detailed fully in the next section.

The four ECore classes EAttribute, EReference, EOperation and Eparameter, are all derived from EtypedElement, which means that instances of them have some type (which is an EClassifier) and inherit the other characteristics of ETypedElement, like multiplicity. Type expressions have two parts. First is a simple identifier or a qualified identifier that identifies some EClassifier. The EClassifier identified may be defined in the same source file as the type expression, or it may be in one of the imported ECore models (specified in import statements).

A number of the basic types have shorthand notation. The table below lists the shorthand and the corresponding ECore type name for each of these basic types as well as the corresponding Java type or class.

TABLE 1
Basic Type Names

| Emfatic | ECore EClassifier | |
|---|---|---|
| Keyword | name | Java type name |
| boolean | Eboolean | boolean |
| Boolean | EBooleanObject | java.lang.Boolean |
| byte | Ebyte | byte |
| Byte | EbyteObject | java.lang.Byte |
| char | Echar | char |
| Character | ECharacterObject | java.lang.Character |
| double | Edouble | double |
| Double | EDoubleObject | java.lang.Double |
| float | Efloat | float |
| Float | EfloatObject | java.lang.Float |
| int | Eint | int |
| Integer | EIntegerObject | java.lang.Integer |
| long | Elong | long |
| Long | ElongObject | java.lang.Long |
| short | Eshort | short |
| Short | EshortObject | java.lang.Short |
| Date | Edate | java.util.Date |
| String | Estring | java.lang. String |
| Object | EjavaObject | java.lang.Object |
| Class | EjavaClass | java.lang.Class |
| Eobject | Eobject | org.eclipse.emf.ecore.EObject |
| Eclass | Eclass | org.eclipse.emf.ecore.EClass |

These types and the types in ECore may also be referenced by using their fully qualified name, which begins with the package prefix “ecore”. For example ecore.EOperation and ecore.EBiglnteger are also legal references to types in Ecore.ecore.

The second part of a type expression is the multiplicity expression, which maps to the lowerBound and upperBound attributes of ETypedElement. Multiplicity expressions are optional, but when omitted the generated ETypedElement gets the defaults (lowerBound=0 and upperBound=1). The mapping between various multiplicity expressions and the lowerBound and upperBound attributes of the generated ETypedElement is detailed more fully in the following table.

TABLE 2
Multiplicity Expressions

| Emfatic multiplicity | ETypedElement | ETypedElement |
|---|---|---|
| expression | lowerBound | upperBound |
| none | 0 | 1 |
| [?] | 0 | 1 |
| [ ] | 0 | unbounded (−1) |
| [*] | 0 | unbounded (−1) |
| [+] | 1 | unbounded (−1) |
| [1] | 1 | 1 |
| [n] | n | n |
| [0 . . . 4] | 0 | 4 |
| [m . . . n] | m | n |
| [5 . . . *] | 5 | unbounded (−1) |
| [1 . . . ?] | 1 | unspecified (−2) |

Sometimes it is necessary or desirable to use a keyword as the name for some model element. This can be achieved by prefixing the name identifier with the ‘˜’ symbol. Recall that the abstract and interface keywords are used in class declarations. The code above shows how they can be used as attribute names. Emfatic removes the ‘˜’ symbol so names in the generated ECore model do not contain it.

The ECore class features EAttribute, EReference, EOperation and EParameter are represented in Emfatic as follows. The example below is the class EPackage from Ecore.ecore and it was chosen to give a feel for the feature syntax because it contains a sample of each kind of class feature.

class EPackage extends ENamedElement {

op EClassifier getEClassifier(EString name);
attr EString nsURI;
attr EString nsPrefix;
transient !resolve ref EFactory[1]#ePackage eFactoryInstance;
val EClassifier[*]#ePackage eClassifiers;
val EPackage[*]#eSuperPackage eSubpackages;
readonly transient ref EPackage#eSubpackages eSuperPackage;

}

The syntax for class features is based on the syntax of Java with one key difference. In Java some elements are introduced with special keywords like class and interface, but type members like fields and methods have no such keywords to introduce them. This works for Java because fields and methods can be distinguished by looking at other syntactic features (methods have parenthesis and fields do not). However the distinction between what EMF calls attributes and references doesn't really exist in Java, so there is no distinguishing syntax. Because of this and because class features are such an essential element of EMF, keywords are used to introduce and differentiate attributes, references and operations. Thus, the basic syntax for a class feature looks like this:

modifiers featureKind typeExpression name ‘;’ Where featureKind is one of the four keywords in the following table.

TABLE 3
Class Feature Kind Keywords

| Emfatic | |
|---|---|
| keyword | introduces |
| attr | Eattribute |
| op | Eoperation |
| ref | normal EReference (EReference.containment = false) |
| val | “by value” EReference (EReference.containment = true) |

The keyword ref may be preceded by the words readonly and transient. These are modifiers similar to Java's modifiers such as public, private and abstract. However these modifiers map to boolean attributes on the ECore classes involved in defining structural and behavioral features. The table below describes each modifier.

TABLE 4
Class Feature Modifiers

| modifier | means | applies to |
|---|---|---|
| readonly | EStructuralFeature.changeable = | attribute, reference |
| | false | |
| volatile | EStructuralFeature.volatile = | attribute, reference |
| | true | |
| transient | EStructuralFeature.transient = | attribute, reference |
| | true | |
| unsettable | EStructuralFeature.unsettable = | attribute, reference |
| | true | |
| derived | EStructuralFeature.derived = | attribute, reference |
| | true | |
| unique | ETypedElement.unique = true | attribute, reference, |
| | | operation, parameter |
| ordered | ETypedElement.ordered = true | attribute, reference, |
| | | operation, parameter |
| resolve | EReference.resolveProxies = | reference |
| | true | |
| id | EAttribute.iD = true | attribute |

Note that the meaning of a modifier may be negated by prefixing the ! operator. Normally the only modifiers that are negated with ! are unique, ordered and resolve. This is because these three are true by default, so reversing the ECore default means using the! operator. Note also that EStructuralFeature.changeable is true by default, but the modifier keyword readonly means the opposite (EStructuralFeature.changeable=false).

Attributes may also be assigned default value expressions. The declaration of attributes is basically identical to declaring fields in Java except for the presence of the attr keyword. The type expression syntax for references is slightly complicated by the fact that a way to identify the opposite of a reference is needed. Accordingly, the type expressions are followed by a # symbol and an identifier. This identifier may be used to name the EReference, which is the opposite of the reference being declared. If a reference doesn't need to specify its opposite then that part (including the # symbol) is omitted.

The declaration syntax for operations is Java-like as described above, including use of the keyword void to identify operations which don't return a value. Also a Java-like throws clause allows for the declaration of exception types:

Annotations can be attached to every kind of EMF element, however only the source and details features of the resulting EAnnotation can be specified in Emfatic. The @ symbol is followed by the value of the EAnnotation source attribute. Key/value pairs for the annotation details may appear in parenthesis following the source value. Multiple annotations can be attached to each element. Usually the annotation appears just before its containing element (parameter and enum literal annotations may appear just after the declaration). One subtle point to note is that double quotes are only required around the string value if it is not a valid simple or qualified identifier. So an identifier like key or key.a.b.c need not be quoted, but most complex strings (such as urls) will need to be.

Short labels may be defined to map to longer URI values for the source attribute of an EAnnotation. The purpose of this feature is to simplify the code, making it easier to read and edit. Several annotation labels are available by default.

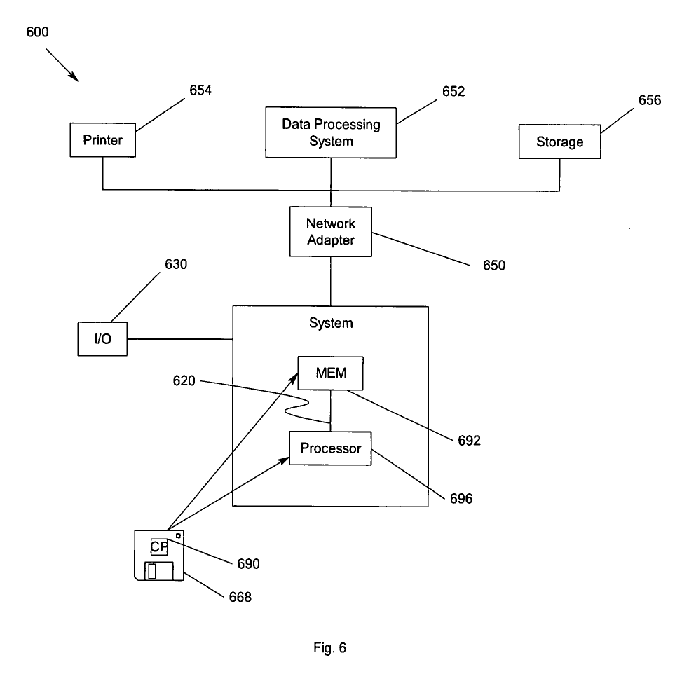

FIG. 6 illustrates a system 600 according to an embodiment of the present invention. Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 690 accessible from a computer-usable or computer-readable medium 668 providing program code for use by or in connection with a computer or any instruction execution system.

For the purposes of this description, a computer-usable or computer readable medium 668 can be any apparatus that can contain, store, communicate, propagate, or transport the program for use by or in connection with the instruction execution system, apparatus, or device. The medium 668 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A system suitable for storing and/or executing program code will include at least one processor 696 coupled directly or indirectly to memory elements 692 through a system bus 620. The memory elements 692 can include local memory employed during actual execution of the program code, bulk storage, and cache memories which provide temporary storage of at least some program code in order to reduce the number of times code must be retrieved from bulk storage during execution.

Input/output or I/O devices 640 (including but not limited to keyboards, displays, pointing devices, etc.) can be coupled to the system either directly to the system or through intervening I/O controllers.

Network adapters 650 may also be coupled to the system to enable the system to become coupled to other data processing systems 652, remote printers 654 or storage devices 656 through intervening private or public networks 660. Modems, cable modem and Ethernet cards are just a few of the currently available types of network adapters.

Accordingly, the computer program 690 comprise instructions which, when read and executed by the system 600 of FIG. 6, causes the system 600 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A data structure stored on a computer-readable medium, the data structure comprising elements for selecting files for processing and a syntax for representing models in textual form such that, when the data structure is read by a computing device, the computing device can map between a model of an application and a source file representing the model.

2. The data structure of claim 1, wherein the syntax allows a compiler to read the source code file and produce an equivalent model.

3. The data structure of claim 2, wherein the syntax allows a decompiler to read a model and produce an equivalent source code file.

4. The data structure of claim 1, wherein the syntax allows a decompiler to read a model and produce an equivalent source code file.

5. The data structure of claim 1, wherein the syntax is readable by an editor for use in editing the source code file.

6. The data structure of claim 1, wherein the model comprises an Eclipse Model Framework Ecore model.

7. A method for working with a model framework for software development, comprising:
selecting information from a group comprising a model and source code representing the model; and
producing a counterpart to the selected information.

8. The method of claim 7 further comprising switching between a view of the selected information and the produced counter-part.

9. The method of claim 8 further comprising opening an editor to make modifications to the source code when source code is selected.

10. The method of claim 7, wherein the selecting information comprises creating textual information for producing a model.

11. The method of claim 10, wherein the creating textual information for producing a model further comprises mapping model constructs and textual syntax of the source code.

12. The method of claim 10 further comprising defining a package hierarchy.

13. The method of claim 12, wherein the package hierarchy includes a main package and nested subpackages.

14. The method of claim 7, wherein the model comprises an Eclipse Model Framework Ecore model.

15. A computer readable medium having instructions for causing a computer to execute the operations of claim 7.

16. An apparatus, comprising:
a processor; and
a memory coupled to said processor and operable to store program instructions in a platform-independent programming language, wherein the program instructions are executable by the processor to:
provide a representation of a computer program selected from a group comprising a model and source code representing the model; and
produce a counterpart to the selected representation of the computer program.

17. The apparatus of claim 15, wherein the program instructions are further executable by the processor to allow switching between a view of the selected information and the produced counter-part.

18. The apparatus of claim 15, wherein the program instructions are further executable by the processor to open an editor to make modifications to the source code when source code is selected.

19. The apparatus of claim 15, wherein the program instructions are further executable by the processor to provide a compiler and a decompiler, the compiler reading the source code file and producing an equivalent model and the decompiler reading a model and producing an equivalent source code file.

20. The apparatus of claim 15, wherein the program instructions are further executable by the processor to create textual information for producing a model.
